(19) United States
(12) Patent Application Publication
(10) Pub. No.: US 2015/0091357 A1
(43) Pub. Date: Apr. 2, 2015

(54) Portable Bolster

(71) Applicant: Joanne G. Register, Jacksonville, FL (US)

(72) Inventor: Joanne G. Register, Jacksonville, FL (US)

(21) Appl. No.: 14/501,918

(22) Filed: Sep. 30, 2014

Related U.S. Application Data
(60) Provisional application No. 61/884,401, filed on Sep. 30, 2013.

(51) Int. Cl. A47C 20/02; B60N 2/46

(52) U.S. Cl. CPC A47C 20/023; B60N 2/46; A47C 20/02
USPC 297/411.23

(57) ABSTRACT

A portable bolster having a substantially cylindrical configuration, the bolster being composed of filler padding retained within a fabric body, a high-friction, non-slip bottom external layer or member, and an internal weight member located in the bottom of the interior of the fabric body. Preferably, the bolster comprises an inner tubular member and inner end members forming a closed cylinder, the inner tubular member being disposed within an outer tubular member having outer end members, the outer end members of the outer tubular member being contracted or cinched to draw the material about the inner end members while preferably leaving an opening such that the a portion of the inner end members is exposed.

This application claims the benefit of U.S. Provisional Patent Application Ser. No. 61/884,401, filed Sep. 30, 2013.

### BACKGROUND OF THE INVENTION

This invention relates generally to a portable bolster, which is defined as a long narrow cushion or padded support device, structured and designed to be placed onto a surface to provide raised support for one's arm, head, etc. Such devices are well known and are typically utilized with couches, benches and chairs, as well as in automobiles, acting as an arm rest between seats when there is no arm rest present or when the center console is too low to offer adequate and comfortable support.

Examples of portable bolsters are shown in U.S. Pat. No. 2,006,883 to Davies et al., U.S. Pat. No. 2,086,244 to Smith, U.S. Pat. No. 2,525,659 to Gorman, U.S. Pat. No. 2,692,638 to Castell, U.S. Pat. No. 3,083,998 to Morris, U.S. Pat. No. 3,118,704 to Meserve, U.S. Pat. No. 3,428,357 to Lueck, U.S. Pat. No. 3,951,453 to Zapf, U.S. Pat. No. 4,019,779 to Hogan, U.S. Pat. No. 4,858,995 to Young, U.S. Pat. No. 5,911,472 to Toth, U.S. Pat. No. 5,971,487 to Passehl, U.S. Pat. No. 6,981,735 to Stephens, U.S. Pat. No. 7,334,838 to Pope, U.S. Pat. No. 7,448,675 to Lowery, and U.S. Pat. No. D431,944 to Cazarez et al.

It is an object of this invention to provide a portable bolster, cylindrical in shape, suitable for use in automobiles or with furniture, the bolster being weighted and provided with a high-friction, non-skid lower outer layer, such that the bolster remains in position without requiring fastener mechanisms of any type. It is a further object to provide a bolster having a method of construction that presents a decorative appearance with simplicity of manufacture, reduction in cost and variability of decorative features.

### SUMMARY OF THE INVENTION

The invention is a portable bolster having a substantially cylindrical configuration, the bolster composed of filler padding retained within a fabric body, a high-friction, non-slip bottom outer layer or member to minimize slippage of the bolster when placed on a support surface, and an internal weight member located in the bottom or lower portion of the interior of the fabric body in order to better secure the bolster in its desired position, to lower the center of gravity of the bolster and to minimize rotation and axial movement of the bolster. Preferably, the bolster comprises an inner tubular member and inner end members, the inner tubular member being disposed within an outer tubular member having outer end members, the outer end members of the outer tubular member being cinched to draw the material about the inner end members while leaving an opening such that the a portion of the inner end members are exposed. With this construction the outer tubular member, outer end members and inner end member may be constructed with a decorative fabric or similar material while the inner tubular member may be formed of a plain and less expensive material.

In alternative wording, the invention in various embodiments comprises a portable cylindrical bolster comprising a main body, filler material retained with said main body, a weight member retained within said main body, and an external high-friction layer, said high-friction layer and said weight member being positioned substantially adjacent to each other; wherein said main body comprises an inner tubular member received within an outer tubular member, and wherein said filler material and said weight member are retained within said inner tubular member; wherein said main body further comprises inner end members connected to said inner tubular member, whereby the combination of said tubular inner member and said inner end members fully encase said filler material and said weight member; wherein said main body further comprises outer end members connected to said outer tubular member, and further comprising cinching members disposed on each outer end member such that said cinching members are adapted to draw together said outer end members to enclose said inner tubular member within said outer tubular member; wherein an opening is formed in each of said outer end members when said outer end members are drawn together by said cinching member, such that a portion of said inner end members remain visible. Further, such a bolster wherein said inner end members and said inner tubular member are made of different material; wherein said outer end members and said inner end members are made of different material; wherein said cinching members each comprise a drawstring; wherein said cinching members each comprise an elastic member; and/or wherein said outer tubular member comprises said high-friction layer joined to a rectangular fabric or film member to define a tube.

### BRIEF DESCRIPTION OF THE DRAWINGS

FIG. 1 is a side view of an embodiment of the invention.

FIG. 2 is a bottom view of the embodiment of FIG. 1.

FIG. 3 is an end view of the embodiment of FIG. 1.

FIG. 4 is a cross-sectional view taken along line 4-4 of FIG. 1.

FIG. 5 is a cross-sectional view taken along line 5-5 of FIG. 1.

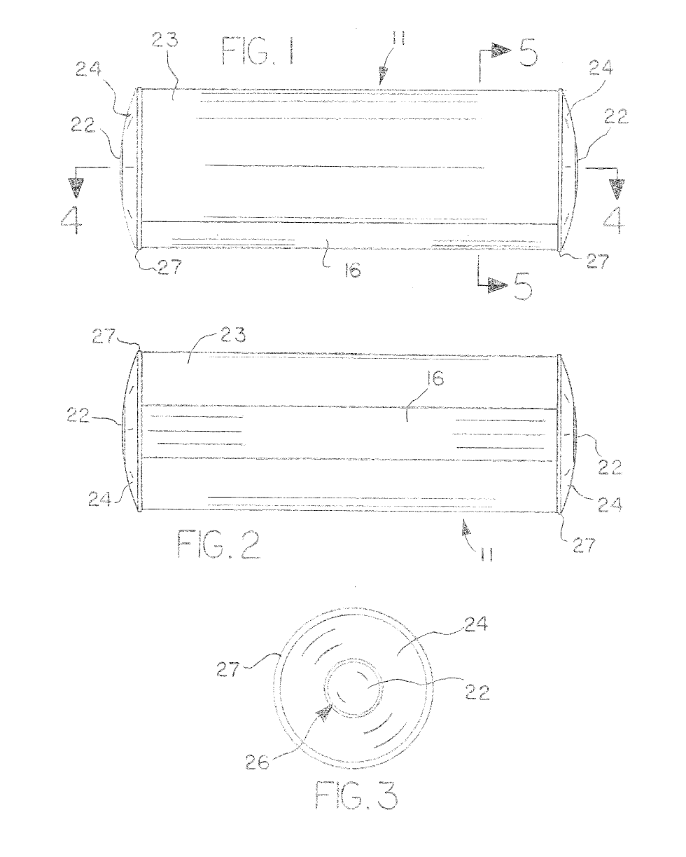

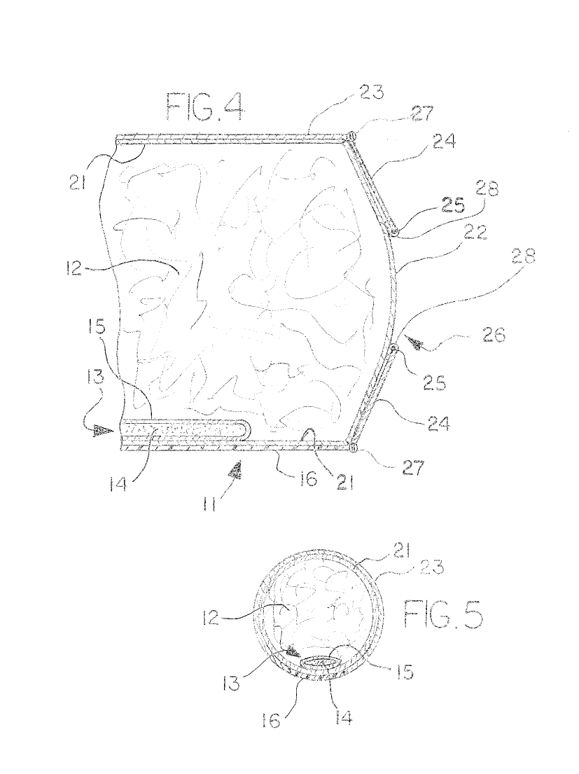

### DETAILED DESCRIPTION OF THE INVENTION

With reference to the drawings, the invention will now be described in detail. In general, the invention is a portable padded bolster suitable for use on furniture or within an automobile, the bolster providing cushioned support to an individual's arm, head, etc. The bolster is constructed of sufficient weight and structural integrity that it may be utilized, for example, in an automobile without shifting or sliding during acceleration, turning or braking.

As seen in the figures, the portable bolster has a substantially cylindrical configuration, the bolster comprising a cylindrical main body 11, the main body 11 comprising filler material 12, such as padding, fibrous wads or the like, encased and retained within a fabric, film or similar sheet material, a high-friction, non-slip external bottom layer or member 16, and an internal weight member 13 located in the bottom of the interior of the main body 11.

The weight member 13 extends longitudinally within the main body 11, and preferably extends substantially the full length of the main body 11. The weight member 13 may comprise a solid body or bodies, but preferably comprises a weight filler material 14, such as sand, metal beads or the like, encased within a weight envelope 15 composed of a fabric or similar sheet material. The profile of the weight member 13 is preferably relatively flat, as the purpose of the weight member 13 is to minimize rotation of the main body 11 about its longitudinal axis and to minimize slippage in either axial direction by providing the bolster with a low center of gravity.

The flexible, high-friction, non-slip external layer 16 is disposed on or forms the bottom of the main body 11, and may comprise a rubber or polymer material having rubber-like properties, such as for example a neoprene material. The high-friction layer 16 may be secured using stitching, adhesive, heat bonding or similar suitable methods. The high-friction layer 16 may also be applied as a coating to the main body 11.

Preferably, the bolster comprises an inner tubular member 21 and inner end members 22, the combination of the inner tubular member 21 and inner end members 22 defining and forming a closed assembly that retains the filler padding material 12 and the weight member 13. The weight member 13 is positioned radially outward from the central axis of the inner tubular member 21, such that it is located adjacent or near the outer wall of the inner tubular member 21. The inner tubular member 21 and inner end members 22 are disposed within an outer sleeve or tubular member 23 whereby the combination defines the main body 11, the outer tubular member 23 having annular or sleeve-like outer end members 24 each provided with a cinching member 25, such as a string or elastic cord, positioned within an annular sleeve 28 disposed on the outer edges of the outer end members 24, such that each outer end member 24 may be tightened or cinched together to retain the inner tubular member 21 within the outer tubular member 23. The outer high-friction layer 16 is either affixed on the exterior of the outer tubular member 23, or the outer tubular member 23 is created by edge joining a rectangular high-friction layer 16 to a rectangular fabric or film portion to create the outer tubular member 23. The inner tubular member 21 is inserted within the outer tubular member 23 such that the weight member 13 is positioned adjacent the high-friction layer 16, this combination defining the bottom of the bolster. The cinching members 25 are then allowed to contract or are drawn to pull together the outer end member 25, thereby drawing the outer end members 25 together and closing off the ends of the inner tube member 21 so as to enclose, secure and retain the inner tubular member 21 within the outer tubular member 23. Most preferably, the length of the closed outer end members 25 in the radial direction is less than the radius of the inner tubular member 21, such that openings 26 remain through which the inner end members 22 are exposed.

With this construction the outer tubular member 23, outer end members 24 and inner end members 22 may be constructed with a decorative fabric or similar material while the inner tubular member 21 may be formed of a plain and less expensive material. Furthermore, the outer tubular member 23 and outer end members 24 formed of one decorative fabric are interchangeable during manufacture with inner end members 22 formed of a different decorative fabric such that bolsters of different aesthetics may be easily created. Annular decorative piping 27 may also be provided at the shoulder junction of the outer end members 24 and the outer tubular member 23.

It is understood and contemplated that equivalents and substitutions for elements set forth above may be obvious to those of skill in the art, and therefore the true scope and definition of the invention is to be as set forth in the following claims.

I claim:

1. A portable cylindrical bolster comprising a main body, filler material retained with said main body, a weight member retained within said main body, and an external high-friction layer, said high-friction layer and said weight member being positioned substantially adjacent to each other.

2. The bolster of claim 1, wherein said main body comprises an inner tubular member received within an outer tubular member, and wherein said filler material and said weight member are retained within said inner tubular member.

3. The bolster of claim 2, wherein said main body further comprises inner end members connected to said inner tubular member, whereby the combination of said tubular inner member and said inner end members fully encase said filler material and said weight member.

4. The bolster of claim 3, wherein said main body further comprises outer end members connected to said outer tubular member, and further comprising cinching members disposed on each outer end member such that said cinching members are adapted to draw together said outer end members to enclose said inner tubular member within said outer tubular member.

5. The bolster of claim 4, wherein an opening is formed in each of said outer end members when said outer end members are drawn together by said cinching member, such that a portion of said inner end members remain visible.

6. The bolster of claim 5, wherein said inner end members and said inner tubular member are made of different material.

7. The bolster of claim 5, wherein said outer end members and said inner end members are made of different material.

8. The bolster of claim 6, wherein said outer end members and said inner end members are made of different material.

9. The bolster of claim 4, wherein said cinching members each comprise a drawstring.

10. The bolster of claim 4, wherein said cinching members each comprise an elastic member.

11. The bolster of claim 2, wherein said outer tubular member comprises said high-friction layer joined to a rectangular fabric or film member to define a tube.
